(19) United States
(12) Patent Application Publication
(10) Pub. No.: US 2026/0248325 A1
(43) Pub. Date: Aug. 27, 2026

(54) DEVICE TO PROVIDE ALTERNATE FEATURES FOR A BLENDER CONTAINER

(71) Applicant: Vita-Mix Management Corporation, Olmsted Township, OH (US)

(72) Inventors: Mark J. Mayer, Sagamore Hills, OH (US); Thomas Clynne, Lakewood, OH (US); Gary Utterback, Novelty, OH (US)

(73) Assignee: Vita-Mix Management Corporation, Olmsted Township, OH (US)

(21) Appl. No.: 19/467,122

(22) Filed: Feb. 2, 2026

Related U.S. Application Data
(60) Provisional application No. 63/762,908, filed on Feb. 25, 2025.
(60) Provisional application No. 63/753,202, filed on Feb. 3, 2025.

(51) Int. Cl. A47J 43/07; A47J 43/046; B01F 27/808; B01F 27/906; B01F 35/21; B01F 35/45; B01F 35/71; B01F 101/00

(52) U.S. Cl. CPC A47J 43/0716; A47J 43/046; A47J 43/0772; B01F 27/808; B01F 27/906; B01F 35/2112; B01F 35/2113; B01F 35/2115; B01F 35/45; B01F 35/7176; B01F 2101/1805

(57) ABSTRACT

A blender container including a body at least partially formed from a non-transparent material, a lid provided on an upper end of the body, the lid defining an opening, and an auxiliary cover positionable over the opening of the lid and coupled to the lid, the auxiliary cover at least partially formed from a transparent material. In aspects, an accessory cover is positionable over the opening of the lid and coupled thereto, the accessory cover defining one or more apertures for receiving associated accessories. A pump and a dispenser may extend through the accessory cover.

### CROSS-REFERENCE TO RELATED APPLICATIONS

This application claims the benefit of co-pending U.S. Provisional Patent Application Serial No. 63/753,202, filed February 3, 2025, and co-pending U.S. Provisional Patent Application Serial No. 63/762,908, filed February 25, 2025, both of which are hereby incorporated by reference in their entirety including the drawings.

### TECHNICAL FIELD

The present specification generally relates to blender containers and, more specifically, systems and methods for providing features in a blender container with a lid secured to a blender container body.

### BACKGROUND

Blender systems are often used to blend and process foodstuffs. Conventional blenders generally include a base with a motor, a mixing container with an operable mixing blade disposed therein. A blender lid is adapted to cover the mixing container. A user inserts contents within the mixing container to be mixed by the rotation of the blade. The container is positioned on the base as a user controls the operation of the motor within the base to rotate the mixing blade within the container to mix the contents therein.

By and large, most blender containers are intended to be picked up by an operator and have the blended contents poured out. This can be cumbersome and heavy, as well as dangerous in some instances, such as when a temperature of the blended contents has increased due to the blending process. Additionally, blender containers including dispensing systems are cumbersome and difficult to clean. For example, some blender containers incorporate a spigot or valve near the bottom of a body of the blender container that can be opened at any point during a blending process to extract content. These spigots and valves tend to be hard to clean as they often utilize a somewhat circuitous path that can trap material and provide a source for bacterial growth and contamination.

An unmet need exists for providing an efficient method of dispensing materials from a blender container. Accordingly, there exists a need to provide additional features for contents that are intended to be dispensed from blender containers such as low speed stirring, temperature measurement, ingredient addition, and the like, which are suitable for cleaning.

### SUMMARY

In one aspect, a blender system includes: a blender container including: a body comprising an upper end defining an opening, a lower end defining a closed end, and a side wall, wherein the side wall and the lower end define an interior cavity; a lid positionable on an upper end of the body, the lid defining an opening; and an accessory cover that is positionable over the opening of the lid and coupled thereto, the accessory cover defining a first aperture and a second aperture; a first accessory extending through the first aperture, the first accessory performing a first function within an interior cavity of the body of the blender container; and a second accessory extending through the second aperture, the second accessory performing a second function within an interior cavity of the body of the blender container different than the first function performed by the first accessory.

In another aspect, a blender container includes: a body; a lid provided on an upper end of the body, the lid defining an opening; an accessory cover positionable over the opening of the lid and coupled to the lid; a first accessory extending through the accessory cover including: a pump; and a dispenser; and a second accessory extending through the accessory cover.

In yet another aspect, a blender system includes: a blender base; a base attachment operatively attached to the blender base; and a blender container operatively attached to the base attachment, the blender container including: a body; a lid provided on an upper end of the body, the lid defining an opening; and an accessory cover that is positionable over the opening of the lid and coupled thereto, the accessory cover defining a first aperture and a second aperture; a first accessory extending through the first aperture, the first accessory performing a first function within an interior cavity of the body of the blender container; and a second accessory extending through the second aperture, the second accessory performing a second function within an interior cavity of the body of the blender container different than the first function performed by the first accessory.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts a front view of a blender system, according to one or more aspects shown and described herein;

FIG. 2 depicts a side perspective view of an aspect of a blender container including an accessory cover, according to one or more aspects shown and described herein;

FIG. 3 depicts a top perspective view of the blender container of FIG. 2 including an auxiliary cover, according to one or more aspects shown and described herein;

FIG. 4A depicts a top perspective view of another aspect of a blender container, according to one or more aspects shown and described herein;

FIG. 4B depicts a top perspective view of the blender container of FIG. 4A including a lid, according to one or more aspects shown and described herein;

FIG. 4C depicts a top perspective view of the blender container of FIG. 4A including the lid and an insulating pad, according to one or more aspects shown and described herein;

FIG. 5A depicts a top perspective view of another aspect of a blender container including a handle in an unlocked position, according to one or more aspects shown and described herein;

FIG. 5B depicts a top perspective view of the blender container of FIG. 5A including a lid and the handle in a locked position, according to one or more aspects shown and described herein;

FIG. 5C depicts an enlarged perspective view of the blender container of FIG. 5A including the lid and the handle in the unlocked position, according to one or more aspects shown and described herein;

FIG. 6 depicts a top perspective view of another aspect of a blender container, according to one or more aspects shown and described herein; and

FIG. 7 depicts a top perspective view of another aspect of a blender container, according to one or more aspects shown and described herein.

### DETAILED DESCRIPTION

Aspects described herein are directed to blender containers permitting various attachments and accessories to be installed. The blender container includes a body, a lid provided on an upper end of the body, the lid defining an opening, and an auxiliary cover positionable over the opening of the lid and coupled the lid. The auxiliary cover may be removed and replaced with an accessory cover to accommodate attachment of one or more accessories to facilitate dispensing, mixing, and the like contents within the body.

Various aspects of the blender containers and the operation of the blender containers are described in more detail herein. Whenever possible, the same reference numerals will be used throughout the drawings to refer to the same or like parts.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of aspects described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

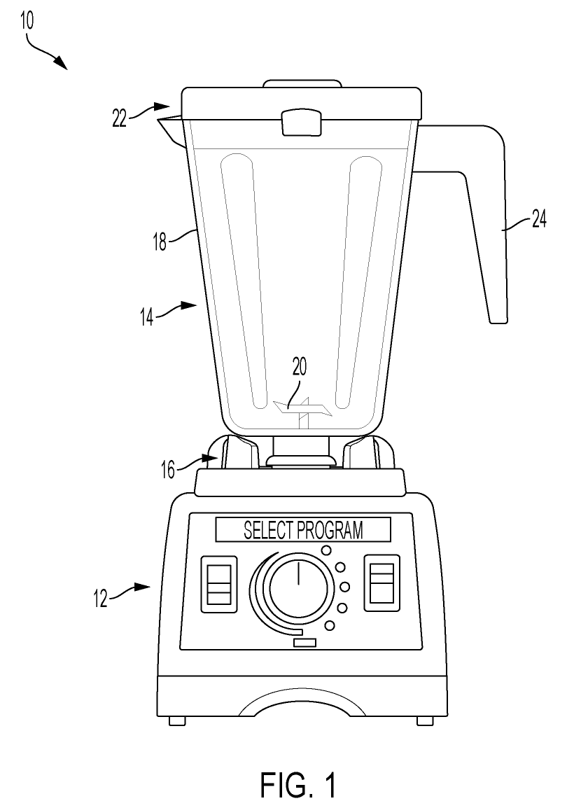

As shown in FIG. 1, the blender system 10 includes a blender base 12, a container 14, and a blade base 16 operatively attached to the container 14. The blade base 16 is operatively attached to the blender base 12. The container 14 includes walls 18 that define an interior cavity in which a blade 20 is received. As shown in FIG. 1, the blender system 10 includes a lid 22 that may be operatively attached to the container 14 to enclose the interior cavity defined by the walls 18. However, it should be appreciated that the blender system 10 may not include the lid 22 such that the container 14 is open at the top end. The container 14 may further include a handle 24. Foodstuff may be added to the interior cavity of the container 14 for blending. The container 14 may be formed from one or more materials such as, but not limited to, plastics, glass, metals, or the like. In another aspect, container 14 may be powered in any appropriate manner, such as by components within the blender base 12, as described herein.

As described in more detail herein, the blade base 16 is removably couplable to the container 14. In addition, the container 14 may be removable couplable to the blender base 12. The blade base 16 may be rotated, moved, or the like by an external source, such as by a motor or the like.

While the container 14 depicted in FIG. 1 is shown as a large-format system, the container 14 may be a single serving style container, such as for example, of a type where the container 14 is filled, the blade base 16 is attached to the container 14, and the container 14 is inverted and placed on the blender base 12 for blending. As can be appreciated, the container 14 depicted in FIG. 1 is one illustrative shape, and the container 14 may be a different size and/or shape without departing from the scope of the present disclosure.

The blender base 12 includes a motor and a power source that is electrically coupled to the motor. In some aspects, the motor may be, but not limited to, an electric motor or the like. The power source includes a switch that is configured to inhibit power from being delivered from the power source to the motor. As described in more detail herein, the motor selectively drives the blade 20 of the blade base 16 when the blade base 16 is properly interfaced with the container 14 and the blender base 12. As a result, the blade base 16 may agitate, or otherwise interact with contents within the interior cavity of the container 14.

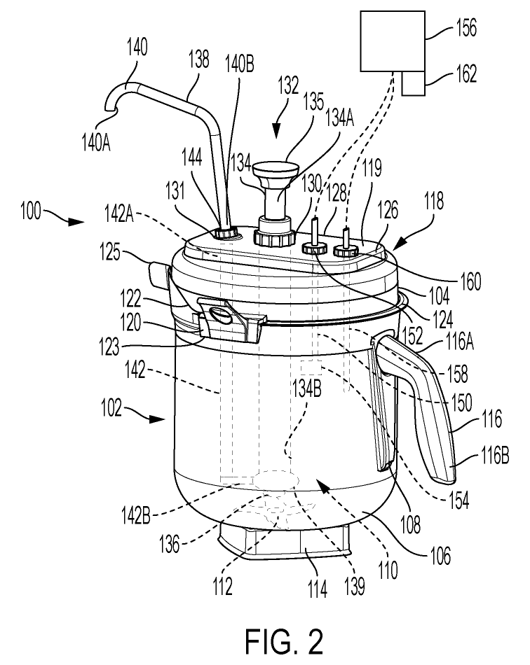

Referring now to FIG. 2, an aspect of a blender container 100 is depicted including a body 102 having an upper end 104, a lower end 106 opposite the upper end 104 defining a closed end, and a side wall 108 extending between the upper end 104 and the lower end 106. The side wall 108 of the body 102 defines an interior cavity 110. In some embodiments, the body 102 may be formed from a non-transparent material such as, for example, metal, stainless steel, or the like. In other embodiments, the body 102 may be formed from transparent material.

A blade is provided at the lower end 106 of the body 102. An apron or base attachment 114 is formed at the lower end 106 of the body 102 for mounting the blender container 100 onto a blender base, such as the blender base 12 shown in FIG. 1, which includes a motor or other attachment device that operates one or more blades positioned within the interior cavity 110 of the body 102. Accordingly, the base attachment 114 may include any suitable mechanism for attaching to the blender base, such as clips, latches, and the like. In other aspects, the base attachment 114 is sized to fit within a recess formed within the blender base and the blender base includes any suitable mechanism for attaching to the base attachment, such as clips, latches, and the like. It should be appreciated that a portion of the blade 112 extends through the base attachment 114 to be operably connected to the blender base, and specifically a motor provided within the blender base, such that the blade may be operated.

The blender container 100 includes a handle 116. In aspects, the handle 116 extends from the side wall 108 of the body 102. However, it should be appreciated that the handle 116 may extend from any suitable location of the body 102. As shown, the handle 116 includes a lateral handle portion 116A and a vertical handle portion 116B. The lateral handle portion 116A extends in a first lateral direction from the side wall 108, and the vertical handle portion 116B extends from an end of the lateral handle portion 116A opposite the side wall 108 in a substantially vertical direction opposite the upper end 104 of the body 102. As described in more detail herein, the handle 116 may have any suitable shape.

Additionally, in aspects, the body 102 includes a lip 124 formed at the upper end 104 of the body 102 defining an opening. The lip 124 extends in an outer radial direction from the side wall 108. In aspects, the lip 124 extends along an entire portion of the upper end 104 of the body 102. In other aspects, the lip 124 extends along a substantial portion of the upper end 104 of the body 102. In aspects, the body 102 includes a spout 125 formed at the upper end 104 of the body 102 to facilitate pouring contents from within the interior cavity 110. In such aspects, the lip 124 terminates on opposite sides of the spout 125. In some aspects, the spout 125 is located opposite the handle 116. However, it should be appreciated that the spout 125 may be located at any suitable location of the body 102.

As shown in FIG. 2, the blender container 100 includes a lid 118 positionable at the upper end 104 of the body 102 to close off the interior cavity 110 of the body 102. As described in more detail herein, the lid 118 may be removably attached to the body 102. In aspects, the lid 118 includes a cover portion 119 and a locking member 120 extending from an edge 122 of the cover portion 119 of the lid 118. In aspects, the lid 118 includes more than one locking member 120. For example, the lid 118 may include a pair of locking members 120 provided at opposite sides of the lid 118 and extending from the edge 122 of the cover portion 119 of the lid 118. In other aspects, the lid 118 includes more than two locking members 120 provided at any suitable location along the edge 122 of the cover portion 119 of the lid 118. The locking member 120 includes an engaging portion 123 that is hingedly attached to the cover portion 119 of the lid 118. The engaging portion 123 may include any suitable mechanism such as, for example, a latch, clamp, or the like, for securing the lid 118 to the body 102, as described in more detail herein.

In aspects, the locking member 120 includes a biasing member positioned between the cover portion 119 and the engaging portion 123. The biasing member applies a biasing force in a first direction against the engaging portion 123 rotating the engaging portion 123 in the first direction and positioning the locking member 120 into a locked position. When a force is applied against the engaging portion 123 in a second direction opposite the first direction, the engaging portion 123 rotates in the second direction and positions the locking member 120 into an unlocked position. In aspects, the locking member 120 may include one or more of a reed switch, magnet, near field communication (NFC) chip, mechanical locking member, push rod, or the like.

With the locking member 120 in the unlocked position, the lid 118 may be positioned onto the body 102. With the lid 118 positioned onto the body 102, the locking member 120 engages the upper end 104 or, more particularly, the lip 124 formed at the upper end 104 of the body 102. Once the force applied against the locking member 120 is alleviated, the biasing member positions the locking member 120 into the locked position to engage the body 102 and become retained thereon.

In aspects, the lid 118 includes an opening 126 formed in a center of the lid 118. As shown, an accessory cover 128 is positioned over the opening 126 and secured to the lid 118. The accessory cover 128 may be secured to the lid 118 in any suitable manner. For example, the accessory cover 128 may be press-fit into the opening 126 formed in the lid 118. In other aspects, the accessory cover 128 and/or the lid 118 may include any suitable mechanisms for attaching to one another, such as clips, clasps, latches, or the like. In aspects, the accessory cover 128 includes a seal, such as a rubber gasket or the like, abutting against the lid 118. The seal may function as an insulated barrier to limit the loss or addition of thermal energy from the interior cavity 110 of the body 102 through the upper end 104 of the body 102.

The accessory cover 128 defines a first aperture 130 and a second aperture 131 for accommodating one or more blending accessories. For example, as shown in FIG. 2, the blending accessory includes a first accessory depicted as a pump mechanism 132 for performing a first function within the interior cavity 110 of the body 102. The pump mechanism 132 includes a pump 134 and a dispenser 138 fluidly coupled to the pump 134. In aspects, the pump mechanism 132 is a manual actuator operable from an exterior of the blender container 100. In other aspects, the pump mechanism 132 is an automatic actuator, such as an electric pump or electric actuator.

With respect to the pump 134, the pump 134 extends through the accessory cover 128, and particularly through the first aperture 130, and into the interior cavity 110 of the body 102 when the accessory cover 128 is attached to the lid 118 and positioned on the body 102. The pump 134 includes an upper end 134A and a lower end 134B opposite the upper end 134A. The lower end 134B of the pump 134 terminates at a predetermined distance above the blade 112 such that the lower end 134B of the pump 134 does not interfere with the blade 112 or any of the other mixing components within the body 102. With the accessory cover 128 attached to the lid 118 and positioned on the body 102, as shown in FIG. 2, the upper end 134A of the pump 134 is positioned at an exterior of the body 102, and the lower end 134B of the pump 134 is positioned within the interior cavity 110 of the body 102. In aspects, a contact member 135 is provided at the upper end 134A of the pump 134 to provide improved comfort to a user when depressing the pump 134 into the interior cavity 110 of the body 102. The pump 134 may be moved into a drawing position by raising the upper end 134A of the pump 134, and moved into a dispensing position by lowering the upper end 134A of the pump 134. The pump 134 may be removable from the accessory cover 128 by sliding the pump 134 through the first aperture 130 to facilitate cleaning of the pump 134 when not in use.

Additionally, the pump mechanism 132 includes a valve 139 provided at the lower end 134B of the pump 134. In aspects, as the pump 134 is operated into the drawing position, the pump 134 draws contents into the pump mechanism 132 from within the interior cavity 110 and the valve 139 permits the contents into the pump mechanism 132. As described in more detail herein, the contents drawn into the pump 134 are then pushed into the dispenser 138 as the pump 134 is operated into the dispensing position.

In aspects, the pump mechanism 132 includes a filter 136 provided at the lower end 134B of the pump 134. The filter 136 limits what enters the pump 134. For example, the filter 136 may limit the size of the contents within the interior cavity 110 of the body 102 to those contents having a particle size less than a predetermined diameter. This ensures that extraneous particles that may be provided within the blender container 100 are not dispensed through the pump mechanism 132. In aspects, the filter 135 is provided instead of the valve 139. In other aspects, the filter 135 is provided in combination to the valve 139.

With respect now to the dispenser 138 of the pump mechanism 132, the dispenser 138 extends through the accessory cover 128, and particularly the second aperture 131, and into interior cavity 110 of the body 102. As shown, the dispenser 138 includes a spout 140 extending from a spigot 142 positioned within the interior cavity 110 of the body 102 and is used to dispense contents from within the interior cavity 110, as described in more detail herein.

In aspects, the spout 140 includes a first end 140A and a second end 140B opposite the first end 140A. The second end 140B of the spout 140 is provided at the second aperture 131. The spout 140 may have any suitable shape. In aspects, the spout 140 is a metal straw or tube.

Similarly, the spigot 142 includes a first end 142A and a second end 142B opposite the first end 142A. The first end 142A of the spigot 142 is provided at the second aperture 131. In aspects, the second end 140B of the spout 140 is attached to the first end 142A of the spigot 142. In other aspects, the spout 140 and the spigot 142 form a unitary member that extends through the second aperture 131. In aspects, the spigot 142 may be a metal straw or tube attached to or formed with the accessory cover 128, which may include one or more guide members for securing the spigot 142 to the accessory cover 128, particularly at the second aperture 131.

The spigot 142 is in fluid communication with the pump 134. In aspects, the second end 142B of the spigot 142 extends directly from the pump 134 at or near the lower end 134B of the pump 134. In other aspects, the second end 142B of the spigot 142 extends directly from the valve 139, which is fluidly coupled to the pump 134. As the pump 134 is operated into the dispensing position by depressing the upper end 134A of the pump 134, the pump 134 pushes contents drawn through the valve 139 from within the interior cavity 110 through the spigot 142 and out of the spout 140.

The dispenser 138 may be removable from the accessory cover 128 by sliding the dispenser 138, including the spout 140 and the spigot 142 in aspects in which the spout 140 and the spigot 142 form a unitary member, through the second aperture 131 to facilitate cleaning of the dispenser 138 when not in use. In aspects in which the spout 140 and the spigot 142 are separately joined to one another, the spout 140 and the spigot 142 may be separately detached from the accessory cover 128. The spout 140 permits the contents to be dispensed by an operator. In aspects, a straw guide 144 is formed in the accessory cover 128 to guide the spout 140 or the spigot 142 extending therethrough.

The accessory cover 128 may accommodate a second accessory for performing a second function different than the first accessory. For example, the second accessory accommodated by the accessory cover 128 may include a stirrer mixing the contents provided within the interior cavity 110 of the blender container 100, a thermometer to measure a temperature of the contents within the interior cavity 110 of the blender container 100, and/or other spigots or chutes to facilitate dispensing the contents before, during, or after a blending operation.

In embodiments, the pump mechanism 132 operates at various speeds, such as a during a low speed stirring operation. As described herein, in embodiments, the accessory cover 128 accommodates a stirrer 150 extending through the accessory cover 128. In embodiments, a stirrer fastener 152 may be fitted around the stirrer or integrated into the stirrer 150 to fix the stirrer 150 to the accessory cover 128, thereby positioning the stirrer 150 at a predetermined position within the interior cavity 110 of the blender container 100. As shown in FIG. 2, the stirrer 150 includes a paddle 154 formed at a distal end of the stirrer 150 opposite the accessory cover 128. Accordingly, the stirrer 150 may be rotated such that the paddle 154 mixes the contents within the interior cavity 110 of the blender container 100.

As described in more detail herein, the stirrer 150 may be communicatively coupled to an electronic control unit 156 for controlling the operating parameters of the stirrer 150, such as the rotation speed, vertical movement of the stirrer 150, rest periods, and the like. In embodiments, the electronic control unit 156 may be any device or combination of components including a processor and non-transitory computer readable memory. The processor of the electronic control unit 156 may be any device capable of executing the machine-readable instruction set stored in the non-transitory computer readable memory. Accordingly, the processor may be an electric controller, an integrated circuit, a microchip, a computer, or any other computing device. The non-transitory computer readable memory of the electronic control unit is coupled to the processor. The non-transitory computer readable memory may include RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in computer programming language, as pre-programmed hardware elements, or as a combination of hardware and software components.

In embodiments, a user interface 162 is communicatively coupled to the electronic control unit 156 to permit user control over the various components described herein. The user interface 162 may include any number of user controls, such as buttons, a touch screen, a display screen, or the like, to allow a user to adjust operating parameters of the components communicatively coupled thereto and to read data collected by those components and transmitted to the user interface 162. As shown in FIG. 2, the user interface 162 is mounted to the electronic control unit 156. However, it should be appreciated that the user interface 162 may be located at any suitable position, such as on the body 102 of the blender container 100.

Although the electronic control unit 156 is depicted as being located externally to the accessory cover 128, it should be appreciated that, in embodiments, the electronic control unit 156 may be integrated into the stirrer 150. In other embodiments, the electronic control unit 156 may be integrated into the accessory cover 128.

In embodiments, the second accessory accommodated by the accessory cover 128 may include a sensor 158 extending through the accessory cover 128. In embodiments, a sensor fastener 160 may be fitted around the sensor 158 or integrated into the sensor 158 to fix the sensor 158 to the accessory cover 128, thereby positioning the sensor 158 at a predetermined position within the interior cavity 110 of the blender container 100.

In embodiments the sensor 158 includes a temperature sensor for detecting a temperature within the interior cavity 110 of the blender container 100. Measuring temperature can provide an end point for blends, such as soup and the like, as well as indicate a current condition to a user. The temperature sensor may include a mechanical thermometer, such as a digital thermometer with a digital display, or the like.

In embodiments, the sensor 158 includes a pressure sensor to indicate one or more conditions in and around the blade 20 (FIG. 1) at the bottom of the blender container 100. It should be appreciated that, while temperature can be sensed at any point within the container 110, pressure would be best sensed below the blade 20.

In embodiments, the sensor 158 may include other types of sensing devices, such as a pH sensor, a level sensor including a time of flight sensor or a float sensor, flow-meters, viscometers, accelerometers, and the like. Additionally, although only one sensor 158 is shown being accommodated in the accessory cover 128, it should be appreciated that a plurality of sensors 158 may be provided simultaneously extending through the accessory cover 128. Accordingly, the blender container 100 may include any combination of the various sensing devices described herein, such as a temperature sensor, a pressure sensor, and/or a level sensor. In embodiments, the accessory cover 128 may accommodate other accessories, such as heater attachments, strainer-type inserts like steamer baskets or infuser baskets, or the like. These additional accessories may or may not be used in combination with the other components and sensing devices described herein.

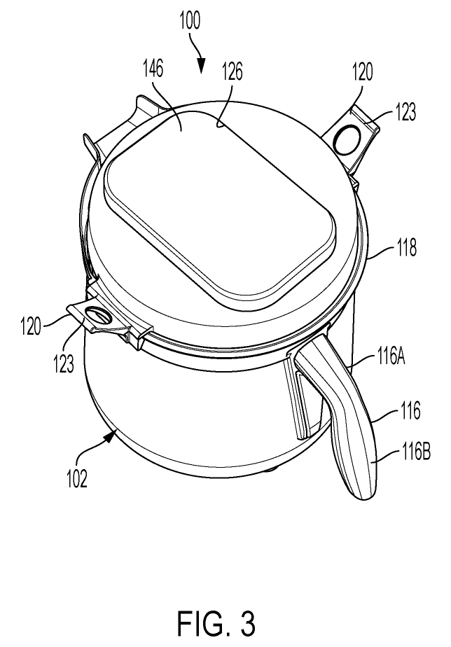

Referring now to FIG. 3, the blender container 100 is shown with the accessory cover 128 (FIG. 2) removed and, instead, an auxiliary cover 146 installed at the opening 126 of the lid 118. The auxiliary cover 146 generally has the same outer shape as the accessory cover 128 and may be secured to the lid 118 in a similar manner. However, the auxiliary cover 146 does not include similar apertures or ports to facilitate engagement of one or more blending accessories. In aspects, the auxiliary cover 146 is formed from a transparent material to permit an operator to view the contents within the interior cavity 110 of the body 102 during a blending operation. For example, the auxiliary cover 146 may be formed from polycarbonate, acrylic, Tritan^{TM}, tempered glass, or the like. The auxiliary cover 146 may provide a sound barrier and/or a barrier to prevent operators from contacting the body 102 when hot.

In aspects, the blender container 100 may only be operated if it is confirmed that the lid 118 and the auxiliary cover 146 are properly installed onto the body 102. The proper positioning of the lid 118 and the auxiliary cover 146 may be confirmed in any suitable manner such as communication with the locking member 120 on the lid 118 described herein.

In operation, with reference to FIGS. 2 and 3, the blender container 100 is placed on a blender base, which includes a motor or other attachment device, to be coupled to the base attachment 114 (FIG. 2). Content or ingredients are added into the interior cavity 110 of the body 102, and a blending operation is initiated with the auxiliary cover 146 attached to the lid 118. At some point, the blending operation may be paused, the auxiliary cover 146 may be removed from the lid 118. Th accessory cover 128 is then attached to the lid 118 and one or more blending accessories, such as the pump mechanism 132, are attached to the accessory cover 128 to permit dispensing contents, mixing contents, heating the contents with a heating accessory, or performing some other function. Thereafter, the blending accessories may be removed from the accessory cover 128, the auxiliary cover 146 is attached, and the blending operation is continued.

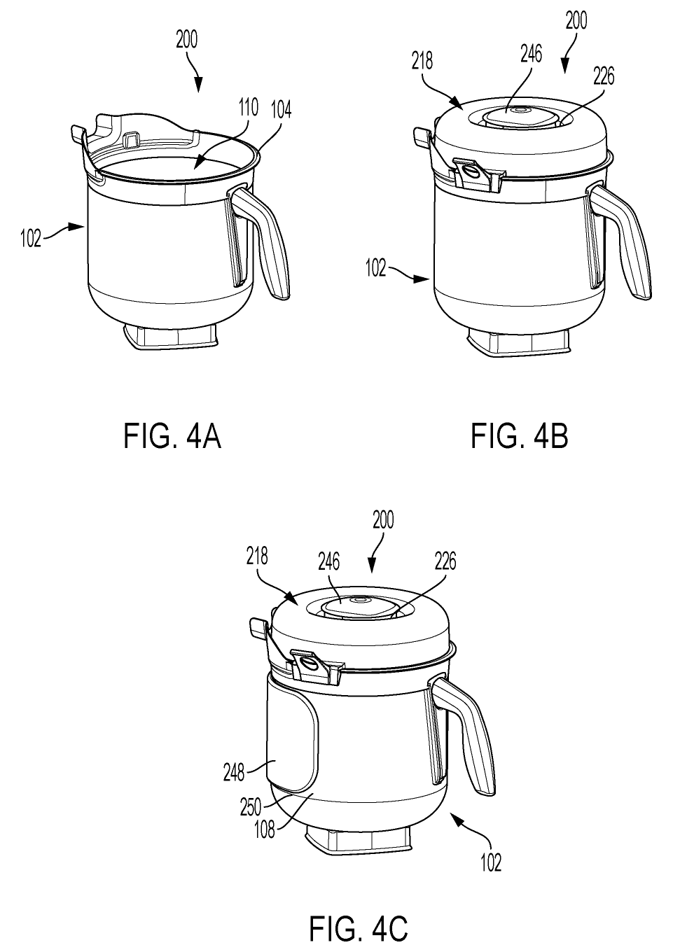

Referring now to FIGS. 4A-4C, another aspect of a blender container 200 is depicted. The blender container 200 includes similar structure to the blender container 100 of FIG. 2. Therefore, like reference numbers will be used to refer to like parts.

As shown in FIG. 4A, the blender container 200 is shown with a lid 218 (FIG. 4B) removed from the body 102. As such, the upper end 104 of the body 102 is shown open to the interior cavity 110 of the body 102. As shown in FIG. 4B, the blender container 200 includes the lid 218 positioned on the upper end 104 of the body 102. The lid 218 differs from the lid 118 of the blender container 100 of FIG. 2 in that an opening 226 formed in the lid 218 is smaller than the opening 126 formed in the lid 118 of the blender container 100 of FIG. 2. Additionally, the opening 226 has a circular shape and an auxiliary cover 246 having a shape corresponding to the shape of the opening 226 is provided over the opening 226 and secured to the lid 218. Accordingly, the auxiliary cover 246 similarly has a circular shape. Similar to the auxiliary cover 146 of the blender container 100 of FIG. 2, the auxiliary cover 246 is formed from a transparent material. With the auxiliary cover 246 removed from the lid 218, one or more blending accessories such as, for example, a spigot, a straw, an actuator, a pump, or the like, may extend through the lid 218 and into the body 102.

As shown in FIG. 4C, the blender container 200 includes a thermal insulating pad 248 provided on an outer surface 250 of the side wall 108 of the body 102. The thermal insulating pad 248 may serve several functions including improved heat resistance and/or improved comfort for aiding an operator when pouring contents out of the blender container 200. In aspects, the thermal insulating pad 248 may be formed from any suitable material such as, for example, silicone, rubber, or the like. The thermal insulating pad 248 may be attached to the side wall 108 of the body 102 in any suitable manner. For example, the thermal insulating pad 248 may be attached to the side wall 108 of the body 102 using an adhesive or the like. Additionally, the thermal insulating pad 248 may have any suitable shape and size. For example, the thermal insulating pad 248 may encircle the side wall 108 of the body 102. In other aspects, the blender container 200 includes a plurality of individual thermal insulating pads 248 adjoined to one another or spaced apart from one another at any suitable location along the side wall 108 of the body 102.

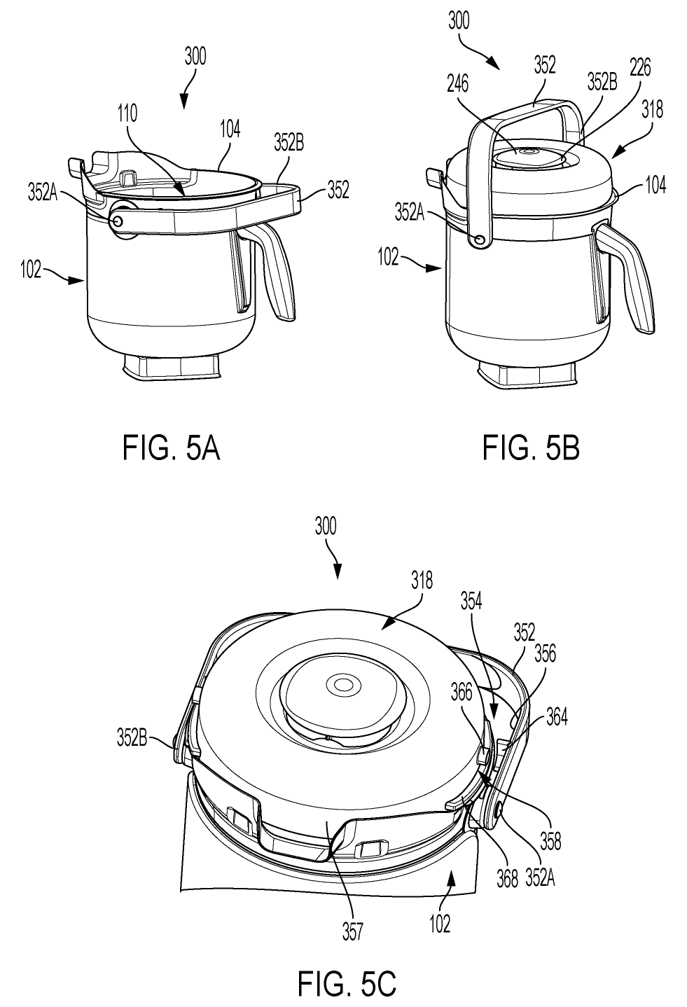

Referring now to FIGS. 5A-5C, another aspect of a blender container 300 is depicted. The blender container 300 includes similar structure to the blender container 100 of FIG. 2. Therefore, like reference numbers will be used to refer to like parts.

As shown in FIG. 5A, the blender container 300 is shown with a lid 318 (FIG. 5B) removed from the body 102. As such, the upper end 104 of the body 102 is shown open to the interior cavity 110 of the body 102. The blender container 300 includes a locking arm 352 pivotally attached to the body 102. Specifically, the locking arm 352 includes a first end 352A and a second end 352B opposite the first end 352A. The first end 352A and the second end 352B are pivotally attached to the body 102 of the blender container 300 in any suitable manner. In aspects, the first end 352A and the second end 352B are spaced apart from the handle 116 so as to avoid interfering with the handle 116 during operation. This particular positioning of the first end 352A and the second end 352B, as well as the handle 116, facilitate two handed operation by an operator. As shown in FIG. 5A, the locking arm 352 is rotated into an unlocked position such that the locking arm 352 is positioned below the upper end 104 of the body 102. The locking arm 352 may be formed from any suitable material such as plastic, metal, or the like. Accordingly, the locking arm 352 may be formed from the same material that forms the body 102 or a different material.

As shown in FIG. 5B, the lid 318 is shown positioned on the upper end 104 of the body 102. It should be appreciated that the lid 318 is similar to the lid 218 of the blender container 200 of FIG. 4B having the opening 226 formed in a center thereof and the auxiliary cover 246 having a shape corresponding to the shape of the opening 226 provided over the opening 226 and secured to the lid 218. Additionally, as shown in FIG. 5B, the locking arm 352 is rotated into a locked position such that the locking arm 352 is positioned above the upper end 104 of the body 102 and above the lid 318. As described in more detail herein, with the locking arm 352 rotated into the locked position, the lid 318 is secured to the body 102 and inhibited from being removed from the body 102. Once the locking arm 352 is rotated into the unlocked position, as shown in FIG. 5A, the lid 318 is permitted to be removed from the body 102.

As shown in FIG. 5C, the locking arm 352 is shown in the unlocked position such that the lid 318 is permitted to be removed.

The locking arm 352 includes an arm locking feature 354 provided on an inner surface 356 of the locking arm 352. The arm locking feature 354 may have any suitable structure for engaging a portion of the lid 318, as described in more detail herein. For example, the arm locking feature 354 may include a clasp, button, latch, magnet, or the like. In aspects, the arm locking feature 354 includes a rib 364 that extends from the inner surface 356 of the locking arm 352. In aspects, the rib 364 has a curved shape. However, it should be appreciated that the rib 364 may have any suitable shape. Additionally, in aspects, the locking arm 352 includes a pair of arm locking features 354, each including a rib 364, extending from the inner surface 356 of the locking arm 352 proximate the first end 352A and the second end 352B of the locking arm 352.

Additionally, as shown in FIG. 5C, the lid 318 includes a lid locking feature 358 provided on an outer surface 357 of the lid 318. The lid locking feature 358 may have any suitable structure for engaging a portion of the locking arm 352, as described in more detail herein. For example, the lid locking feature 358 may include a clasp, button, latch, magnet, or the like. In aspects, the lid locking feature 358 includes a pin 366 that extends from the outer surface 357 of the lid 318. In aspects, the lid locking feature 358 includes a lip 368 positioned below the pin 366. Additionally, in aspects, the lid 318 includes a pair of lid locking features 358, each including a pin 366, and in some aspects a lip 368, extending from the outer surface 357 of the lid 318 on opposite sides of the lid 318.

In operation, the locking arm 352 is initially in the unlocked position such that the rib 364 of the arm locking feature 354 on the locking arm 352 is positioned away from the pin 366 and the lip 368 of the lid locking feature 358 on the lid 318. As the locking arm 352 is rotated from the unlocked position into the locked position, the rib 364 engages the pin 366 and, if provided, is inserted between the pin 366 and the lip 368. Thus, with the rib 364 engaged with the pin 366 and the lip 368, the locking arm 352 inhibits the lid 318 from being removed from the body 102 of the blender container 300. As the locking arm 352 is rotated back into the unlocked position from the locked position, the rib 364 of the arm locking feature 354 disengages the pin 366 and the lip 368, if provided, of the lid locking feature 358. Thereafter, the lid 318 may be removed from the body 102 of the blender container 300.

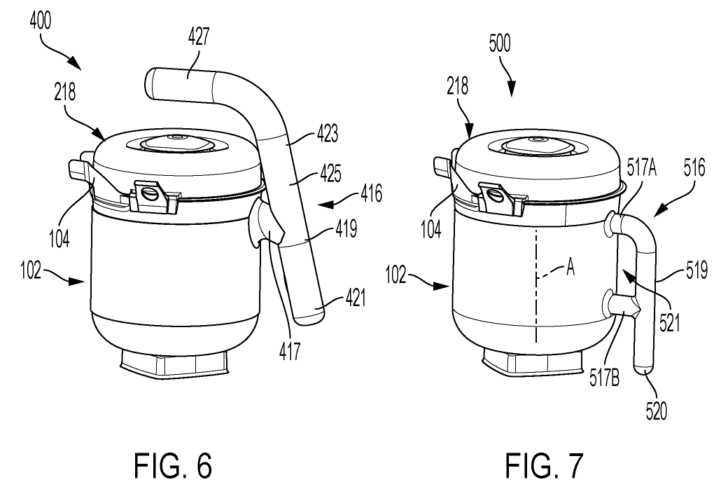

Referring now to FIG. 6, another aspect of a blender container 400 is depicted. The blender container 400 is similar to the blender container 200 of FIG. 4B. Thus, like reference numbers may be used to refer to like parts.

Contrary to the handle 116 of the blender container 100 of FIG. 2, the blender container 400 includes a handle 416. Specifically, the handle 416 includes a lateral projection 417 that extends from the body 102 of the blender container 400 and a handle portion 419 that extends from the lateral projection 417 opposite the body 102. The handle portion 419 includes a lower handle portion 421 that extends downwardly from the lateral projection 417 at an obtuse angle away from the body 102, and an upper handle portion 423 that extends upwardly from the lateral projection 417 at an acute angle toward the upper end 104 of the body 102. Accordingly, the angle between the lateral projection 417 and the lower handle portion 421 is greater than the angle between the lateral projection 417 and the upper handle portion 423.

The upper handle portion 423 defines a first upper handle portion 425 extending from the lateral projection 417, and a second upper handle portion 427 extending from an end of the first upper handle portion opposite the lateral projection 417. The second upper handle portion 427 extends over the upper end 104 of the body 102 and over the lid 218. Accordingly, an operator may grip the second upper handle portion 427 and carry the blender container 400.

Referring now to FIG. 7, another aspect of a blender container 500 is depicted. The blender container 500 is similar to the blender container 200 of FIG. 4B. Thus, like reference numbers may be used to refer to like parts.

Contrary to the handle 116 of the blender container 100 of FIG. 2, the blender container 500 includes a handle 516. Specifically, the handle 516 includes an upper lateral projection 517A and a lower lateral projection 517B that extend from the body 102 of the blender container 500, and a handle portion 519 that extends from the upper lateral projection 517A and the lower lateral projection 517B in a downward direction opposite the upper end 104 of the body 102. The handle portion 519 includes a lower end 520 that terminates lower than the lower lateral projection 517B. The handle portion 519 extends substantially parallel to a vertical axis A of the body 102. A space between the upper lateral projection 517A, the lower lateral projection 517B, and the handle portion 519 defines a grip area 521. Accordingly, an operator may insert their fingers into the grip area 521 and carry the blender container 500.

Further aspects of the aspects described herein are provided by the subject matter of the following clauses:

A blender container, comprising: a body comprising an upper end defining an opening, a lower end defining a closed end, and a side wall, wherein the side wall and the lower end define an interior cavity; a lid positionable on an upper end of the body, the lid defining an opening; and an accessory cover that is positionable over the opening of the lid and coupled thereto, the accessory cover defining a first aperture and a second aperture; a first accessory extending through the first aperture, the first accessory performing a first function within an interior cavity of the body of the blender container; and a second accessory extending through the second aperture, the second accessory performing a second function within an interior cavity of the body of the blender container different than the first function performed by the first accessory.

The blender container of any preceding clause, further comprising an auxiliary cover positionable over the opening of the lid and coupled to the lid.

The blender container of any preceding clause, wherein the first accessory includes a pump or a dispenser.

The blender container of any preceding clause, wherein the second accessory includes a sensor, the sensor including a temperature sensor, a pressure sensor, or a level sensor.

The blender container of any preceding clause, wherein the second accessory includes a stirrer.

The blender container of any preceding clause, wherein the stirrer includes a paddle provided at a distal end of the stirrer opposite the accessory cover.

The blender container of any preceding clause, further comprising an electronic control unit communicatively coupled to the stirrer to operate the stirrer.

The blender container of any preceding clause, further comprising a user interface communicatively coupled to the electronic control unit to permit user control of the stirrer.

The blender container of any preceding clause, further comprising a thermal insulating pad provided on an outer surface of the body.

The blender container of any preceding clause, wherein the lid further comprises a locking member that is engageable with the upper end of the body to selectively lock the lid to the body.

The blender container of any preceding clause, wherein: the body further comprises a locking arm including an arm locking feature; and the lid includes a lid locking feature that engages the arm locking feature when the locking arm is in a locked position.

The blender container of any preceding clause, further comprising a handle extending from the body, the handle comprising a lateral projection extending from the body and a handle portion extending from the lateral projection opposite the body, wherein the handle portion includes an upper handle portion extending upwardly from the lateral projection, the upper handle portion including a first upper handle portion extending upwardly from the lateral projection and a second upper handle portion extending from an end of the first upper handle portion over the upper end of the body.

A blender container, comprising: a body; a lid provided on an upper end of the body, the lid defining an opening; an accessory cover positionable over the opening of the lid and coupled to the lid; a first accessory extending through the accessory cover comprising: a pump ; and a dispenser; and a second accessory extending through the accessory cover.

The blender container of any preceding clause, wherein the dispenser comprises: a straw guide provided on the accessory cover; a spout extending from the straw guide in a first direction; and a spigot extending from the straw guide in a second direction opposite the first direction, the spigot in fluid communication with the pump.

The blender container of any preceding clause, wherein the second accessory comprises a sensor, the sensor including a temperature sensor, a pressure sensor, or a level sensor.

The blender container of any preceding clause, wherein the second accessory comprises a stirrer, wherein the stirrer includes a paddle provided at a distal end of the stirrer opposite the accessory cover.

A blender system, comprising: a blender base; a base attachment operatively attached to the blender base; and a blender container operatively attached to the base attachment, the blender container comprising: a body; a lid provided on an upper end of the body, the lid defining an opening; and an accessory cover that is positionable over the opening of the lid and coupled thereto, the accessory cover defining a first aperture and a second aperture; a first accessory extending through the first aperture, the first accessory performing a first function within an interior cavity of the body of the blender container; and a second accessory extending through the second aperture, the second accessory performing a second function within an interior cavity of the body of the blender container different than the first function performed by the first accessory.

The blender system of any preceding clause, wherein the first accessory includes a pump, a dispenser, or a stirrer.

The blender system of any preceding clause, wherein the second accessory includes a sensor, the sensor including a temperature sensor, a pressure sensor, or a level sensor.

The blender system of any preceding clause, further comprising: an electronic control unit communicatively coupled to the stirrer to operate the stirrer; and a user interface communicatively coupled to the electronic control unit to permit user control of the stirrer.

From the above, it is to be appreciated that defined herein is a blender container including a body, a lid provided on an upper end of the body, the lid defining an opening, and an auxiliary cover positionable over the opening of the lid and coupled to the lid, the auxiliary cover at least partially formed from a transparent material. The auxiliary cover may be removed and replaced with an accessory cover to accommodate attachment of one or more accessories to facilitate dispensing, mixing, and the like contents within the body.

While particular aspects have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A blender system, comprising:
a blender container comprising:
a body comprising an upper end defining an opening, a lower end defining a closed end, and a side wall, wherein the side wall and the lower end define an interior cavity;
a lid positionable on an upper end of the body, the lid defining an opening; and
an accessory cover that is positionable over the opening of the lid and coupled thereto, the accessory cover defining a first aperture and a second aperture;
a first accessory extending through the first aperture, the first accessory performing a first function within an interior cavity of the body of the blender container; and
a second accessory extending through the second aperture, the second accessory performing a second function within an interior cavity of the body of the blender container different than the first function performed by the first accessory.

2. The blender container of claim 1, further comprising an auxiliary cover positionable over the opening of the lid and coupled to the lid.

3. The blender container of claim 1, wherein the first accessory includes a pump or a dispenser.

4. The blender container of claim 1, wherein the second accessory includes a sensor, the sensor including a temperature sensor, a pressure sensor, or a level sensor.

5. The blender container of claim 1, wherein the second accessory includes a stirrer.

6. The blender container of claim 5, wherein the stirrer includes a paddle provided at a distal end of the stirrer opposite the accessory cover.

7. The blender container of claim 6, further comprising an electronic control unit communicatively coupled to the stirrer to operate the stirrer.

8. The blender container of claim 7, further comprising a user interface communicatively coupled to the electronic control unit to permit user control of the stirrer.

9. The blender container of claim 1, further comprising a thermal insulating pad provided on an outer surface of the body.

10. The blender container of claim 1, wherein the lid further comprises a locking member that is engageable with the upper end of the body to selectively lock the lid to the body.

11. The blender container of claim 1, wherein:
the body further comprises a locking arm including an arm locking feature; and
the lid includes a lid locking feature that engages the arm locking feature when the locking arm is in a locked position.

12. The blender container of claim 1, further comprising a handle extending from the body, the handle comprising a lateral projection extending from the body and a handle portion extending from the lateral projection opposite the body,
wherein the handle portion includes an upper handle portion extending upwardly from the lateral projection, the upper handle portion including a first upper handle portion extending upwardly from the lateral projection and a second upper handle portion extending from an end of the first upper handle portion over the upper end of the body.

13. A blender container, comprising:
a body;
a lid provided on an upper end of the body, the lid defining an opening;
an accessory cover positionable over the opening of the lid and coupled to the lid;
a first accessory extending through the accessory cover comprising:
a pump; and
a dispenser; and
a second accessory extending through the accessory cover.

14. The blender container of claim 13, wherein the dispenser comprises:
a straw guide provided on the accessory cover;
a spout extending from the straw guide in a first direction; and
a spigot extending from the straw guide in a second direction opposite the first direction, the spigot in fluid communication with the pump.

15. The blender container of claim 13, wherein the second accessory comprises a sensor, the sensor including a temperature sensor, a pressure sensor, or a level sensor.

16. The blender container of claim 13, wherein the second accessory comprises a stirrer, wherein the stirrer includes a paddle provided at a distal end of the stirrer opposite the accessory cover.

17. A blender system, comprising:
a blender base;
a base attachment operatively attached to the blender base; and
a blender container operatively attached to the base attachment, the blender container comprising:
a body;
a lid provided on an upper end of the body, the lid defining an opening; and
an accessory cover that is positionable over the opening of the lid and coupled thereto, the accessory cover defining a first aperture and a second aperture;
a first accessory extending through the first aperture, the first accessory performing a first function within an interior cavity of the body of the blender container; and
a second accessory extending through the second aperture, the second accessory performing a second function within an interior cavity of the body of the blender container different than the first function performed by the first accessory.

18. The blender system of claim 17, wherein the first accessory includes a pump, a dispenser, or a stirrer.

19. The blender system of claim 17, wherein the second accessory includes a sensor, the sensor including a temperature sensor, a pressure sensor, or a level sensor.

20. The blender system of claim 18, further comprising:
an electronic control unit communicatively coupled to the stirrer to operate the stirrer; and
a user interface communicatively coupled to the electronic control unit to permit user control of the stirrer.
